(19) United States
(12) Patent Application Publication
(10) Pub. No.: US 2025/0215964 A1
(43) Pub. Date: Jul. 3, 2025

(54) DIFFERENTIAL AND VEHICLE INCLUDING THE SAME

(71) Applicants: Hyundai Motor Company, Seoul (KR); Kia Corporation, Seoul (KR); HYUNDAI WIA CORPORATION, Changwon-Si (KR)

(72) Inventors: Tae Hyung LEE, Hwaseong-Si (KR); Jin Woo BYEON, Hwaseong-Si (KR); Kook Lae CHO, Hwaseong-Si (KR); Dong Yun LEE, Incheon (KR)

(73) Assignees: Hyundai Motor Company, Seoul (KR); Kia Corporation, Seoul (KR); HYUNDAI WIA CORPORATION, Changwon-Si (KR)

(21) Appl. No.: 18/680,429

(22) Filed: May 31, 2024

(30) Foreign Application Priority Data
Dec. 29, 2023 (KR) 10-2023-0197134

(51) Int. Cl. F16H 48/22; F16H 48/08

(52) U.S. Cl. CPC F16H 48/22; F16H 48/08; B60K 2023/046; B60Y 2300/84; F16H 2048/085; F16H 48/20; F16H 2048/204; F16H 48/38; F16H 48/40

(57) ABSTRACT

A vehicle may include a first differential configured to allow a difference in speed between left and right wheels of a main driveshaft, a first limited-slip differential configured to selectively restrict a differential operation of the first differential, a second differential configured to allow a difference in speed between left and right wheels of an auxiliary driveshaft, a second limited-slip differential configured to selectively restrict a differential operation of the second differential, and a disconnecting device provided on the auxiliary driveshaft and configured to selectively block power transmitted from a driving source to the auxiliary driveshaft.

### CROSS-REFERENCE TO RELATED APPLICATION

The present application claims priority to Korean Patent Application No. 10-2023-0197134 filed on Dec. 29, 2023, the entire contents of which is incorporated herein for all purposes by this reference.

### BACKGROUND OF THE PRESENT DISCLOSURE

### Field of the Present Disclosure

The present disclosure relates to a vehicle, and more particularly, to a vehicle in which electronic limited-slip differentials are provided on a main driveshaft and an auxiliary driveshaft.

### Description of Related Art

In general, a driveshaft of a vehicle is provided with a limited-slip differential (LSD) that restricts a differential operation implemented by a differential. The limited-slip differential may restrict the differential operation implemented by the differential by adjusting a pressing force to be applied to a clutch.

Generally, the limited-slip differential is mounted only in a main driving wheel. Recently, studies have been conducted to apply the limited-slip differential to an auxiliary driveshaft to improve traveling performance of the vehicle.

Recently, a disconnecting device has been applied to an auxiliary driveshaft to improve electric power economy of an electric vehicle. The disconnecting device may improve electric power economy of the vehicle by blocking power transmitted from a driving source to the auxiliary driveshaft.

However, because of interference between components, it is difficult to install the disconnecting device and the limited-slip differential on the auxiliary driveshaft.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle in which limited-slip differentials are respectively applied to a main driveshaft and an auxiliary driveshaft.

A vehicle according to various exemplary embodiments of the present disclosure may include a first differential configured to allow a difference in speed between left and right wheels of a main driveshaft, a first limited-slip differential configured to selectively restrict a differential operation of the first differential, a second differential configured to allow a difference in speed between left and right wheels of an auxiliary driveshaft, a second limited-slip differential configured to selectively restrict a differential operation of the second differential, and a disconnecting device provided on the auxiliary driveshaft and configured to selectively block power transmitted from a driving source to the auxiliary driveshaft.

In several exemplary embodiments of the present disclosure, the first differential may include: a first ring gear; a first differential case connected to the first ring gear to rotate integrally with the first ring gear; a first spider gear rotatably mounted on the first differential case to rotate and revolve around the main driveshaft; and a pair of first side gears rotatably mounted on the main driveshaft and gear-engaged to the first spider gear.

In several exemplary embodiments of the present disclosure, the first limited-slip differential may include: a first hub clutch coupled to the main driveshaft and configured to rotate integrally with the main driveshaft; a first friction plate coupled to the first hub clutch; a first clutch drum coupled to the first differential case and configured to rotate integrally with the first differential case; and a first metal plate coupled to the first clutch drum.

In several exemplary embodiments of the present disclosure, the main driveshaft and the first hub clutch may be spline-coupled each other.

In several exemplary embodiments of the present disclosure, the first differential case and the first clutch drum may be spline-coupled each other.

In several exemplary embodiments of the present disclosure, the second differential may include: a second ring gear; a second differential case configured to rotate integrally with the second ring gear; an auxiliary differential case configured to be selectively coupled to the second differential case by the disconnecting device; a second spider gear provided on the auxiliary differential case and configured to rotate and revolve around the auxiliary driveshaft; and a second side gear gear-engaged to the second spider gear.

In several exemplary embodiments of the present disclosure, the auxiliary differential case may be provided in the second differential case.

In several exemplary embodiments of the present disclosure, the second limited-slip differential may include: a second hub clutch coupled to the auxiliary driveshaft and configured to rotate integrally with the auxiliary driveshaft; a second friction plate coupled to the second hub clutch; a second clutch drum coupled to the second differential case and configured to rotate integrally with the second differential case; and a second metal plate coupled to the second clutch drum.

In several exemplary embodiments of the present disclosure, the disconnecting device may separate or couple the second differential case and the auxiliary differential case.

A differential according to another exemplary embodiment of the present disclosure may include: a ring gear; a differential case configured to rotate integrally with the ring gear; an auxiliary differential case selectively coupled to the differential case; a spider gear provided on the auxiliary differential case and configured to rotate and revolve around a driveshaft; and a side gear gear-engaged to the spider gear.

In several exemplary embodiments of the present disclosure, the auxiliary differential case may be provided in the differential case.

In several exemplary embodiments of the present disclosure, the differential case may be coupled to one side of a limited-slip differential, and the driveshaft may be coupled to the other side of the limited-slip differential.

In several exemplary embodiments of the present disclosure, the differential case may be coupled to a clutch drum of the limited-slip differential, and the driveshaft may be coupled to a hub clutch of the limited-slip differential.

In several exemplary embodiments of the present disclosure, the differential case and the auxiliary differential case may be separated or coupled by a disconnecting device.

According to the exemplary embodiment of the present disclosure, the electronic limited-slip differentials may be respectively provided on the main driveshaft and the auxiliary driveshaft, improving the traction traveling performance and turning traveling performance of the vehicle.

Other effects, which may be obtained or expected by the exemplary embodiments of the present disclosure, will be directly or implicitly included in the detailed description of the present disclosure. That is, various effects expected according to an exemplary embodiment of the present disclosure will be included in the detailed description to be described below.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

Because the drawings are provided for reference to describe exemplary embodiments of the present disclosure, the technical spirit of the present disclosure should not be construed as being limited to the accompanying drawings.

FIG. 1 is a conceptual view exemplarily illustrating a configuration of a vehicle according to an exemplary embodiment of the present disclosure.

FIG. 2 is a conceptual view exemplarily illustrating configurations of a differential and a limited-slip differential provided on a main driveshaft according to the exemplary embodiment of the present disclosure.

FIG. 3, FIG. 4, FIG. 5 and FIG, 6 are conceptual views exemplarily illustrating configurations of a differential, a limited-slip differential, and a disconnecting device provided on an auxiliary driveshaft according to the exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The terms used herein are merely for describing a predetermined embodiment, and not intended to limit the present disclosure. The singular expressions used herein are intended to include the plural expressions unless the context clearly dictates otherwise. It is to be understood that the term “comprise (include)” and/or “comprising (including)” used in the present specification means that the features, the integers, the steps, the operations, the constituent elements, and/or component are present, but the presence or addition of one or more of other features, integers, steps, operations, constituent elements, components, and/or groups thereof is not excluded. The term “and/or” used herein includes any one or all the combinations of listed related items.

The present disclosure will be described in detail with reference to the accompanying drawings so that those with ordinary skill in the art to which the present disclosure pertains may easily carry out the embodiments. However, the present disclosure may be implemented in various different ways and is not limited to the embodiments described herein.

A part irrelevant to the description will be omitted to clearly describe the present disclosure, and the same or similar constituent elements will be designated by the same reference numerals throughout the specification.

Furthermore, the size and thickness of each component illustrated in the drawings are arbitrarily shown for ease of description, but the present disclosure is not limited thereto. To clearly describe several portions and regions, thicknesses thereof are enlarged.

The suffixes ‘module’, ‘unit’, ‘part’, and/or ‘portion’ used to describe constituent elements in the following description are used together or interchangeably to facilitate the description, but the suffixes themselves do not have distinguishable meanings or functions.

Furthermore, in the description of the included embodiment, the specific descriptions of publicly known related technologies will be omitted when it is determined that the specific descriptions may obscure the subject matter of the exemplary embodiment included in the present specification.

Furthermore, it should be interpreted that the accompanying drawings are provided only to allow those skilled in the art to easily understand the exemplary embodiments included in the present specification, and the technical spirit included in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms.

In the following description, the singular expression “one” or “single” may be interpreted as the singular or plural expression unless explicitly stated.

These terms are used only to distinguish one constituent element from another constituent element.

Hereinafter, a vehicle according to an exemplary embodiment will be described in detail with reference to the accompanying drawings.

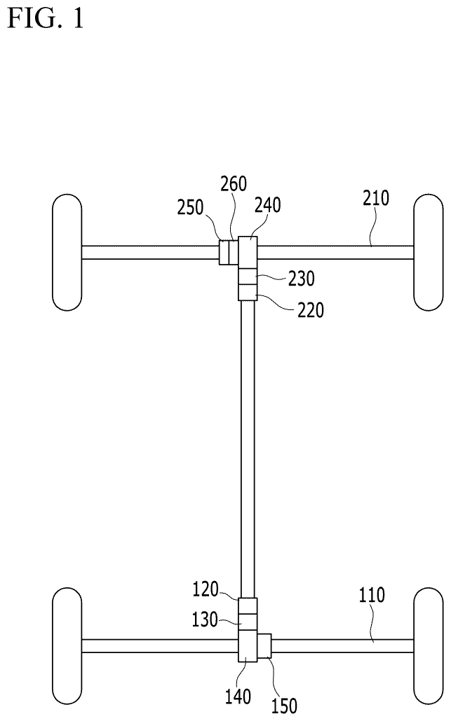

FIG. 1 is a conceptual view exemplarily illustrating a configuration of a vehicle according to an exemplary embodiment of the present disclosure.

As illustrated in FIG. 1, a vehicle according to the exemplary embodiment of the present disclosure may include a first differential 140 provided on a main driveshaft 110 and configured to allow a difference in speed between left and right wheels of the main driveshaft 110, a first limited-slip differential 150 configured to selectively restrict a differential operation of the first differential 140, a second differential 240 configured to allow a difference in speed between left and right wheels of an auxiliary driveshaft 210, a second limited-slip differential 250 configured to selectively restrict a differential operation of the second differential 240, and a disconnecting device 260 provided on the auxiliary driveshaft 210 and configured to selectively block power transmitted from a driving source to the auxiliary driveshaft 210.

First, the first differential 140 and the first limited-slip differential 150 provided on the main driveshaft 110 will be described in detail with reference to the accompanying drawings.

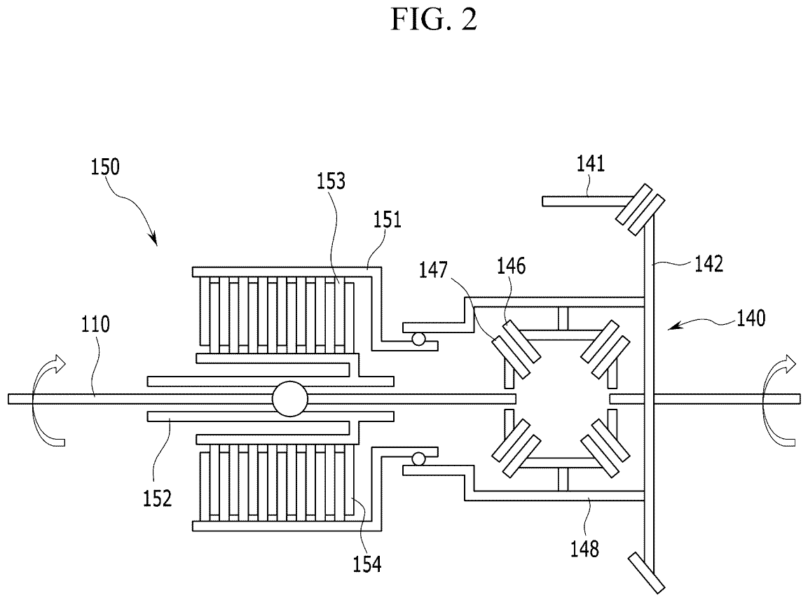

FIG. 2 is a conceptual view exemplarily illustrating configurations of the differential and the limited-slip differential provided on the main driveshaft according to the exemplary embodiment of the present disclosure.

With reference to FIG. 2, the first differential 140 and the first limited-slip differential 150 may be provided on the main driveshaft 110.

The first differential 140 may distribute power, which is transmitted from a first driving source 120 through a first speed reducer 130, to the left and right wheels of the main driveshaft 110. In the exemplary embodiment of the present disclosure, the main driveshaft 110 may be a rear wheel driveshaft.

The first driving source 120 may generate power required to drive the vehicle. The first driving source 120 may be an electric motor or an engine.

The power generated by the first driving source 120 may be transmitted to the left and right wheels of the main driveshaft 110 through the first speed reducer 130 and the first differential 140.

The first differential 140 may allow a difference in speed between the left and right wheels provided at two opposite sides of the main driveshaft 110. To the present end, the first differential 140 may include a first ring gear 142, a first differential case 148, a first spider gear 146, and first side gears 147.

The first ring gear 142 may be gear-engaged to a first pinion gear 141 and rotated by a rotation of the first pinion gear 141.

The first differential case 148 may be coupled to the first ring gear 142 and rotate integrally with the first ring gear 142.

The first spider gear 146 may be provided in the first differential case 148 and rotate integrally with the first differential case 148. The first spider gear 146 may be disposed in the first differential case 148 and rotate and revolve around the main driveshaft 110.

The first side gears 147 may be gear-engaged to the first spider gear 146 and rotated by the rotation of the first spider gear 146. The first side gears 147 may be provided as a pair of first side gears 147, and the pair of first side gears 147 may be rotatably coupled to the main driveshaft 110. Therefore, it is possible to allow the difference in speed between the left and right wheels of the main driveshaft 110.

The first limited-slip differential 150 may restrict the differential operation implemented by the first differential 140 by synchronizing the left and right wheels of the main driveshaft 110.

The first limited-slip differential 150 may include a first clutch pack including first metal plates 153 coupled to a clutch drum 151, and first friction plates 154 coupled to a hub clutch 152.

The first metal plate 153 may be coupled to the clutch drum 151 that rotates integrally with the first differential case 148. Furthermore, the first friction plate 154 may be coupled to the hub clutch 152 that rotates integrally with the main driveshaft 110. The first differential case 148 and the clutch drum 151 may be spline-coupled and rotated integrally. Furthermore, the hub clutch 152 and the main driveshaft 110 may be spline-coupled and rotated integrally.

The left and right wheels of the main driveshaft 110 may be synchronized by clutch torque generated by contact between the first friction plate 153 and the first metal plate 154, and the differential operation between the first spider gear 146 and the first side gear 147 of the first differential 140 may be restricted.

Next, the second differential 240, the disconnecting device 260, and the second limited-slip differential 250 provided on the auxiliary driveshaft 210 will be described in detail with reference to the accompanying drawings.

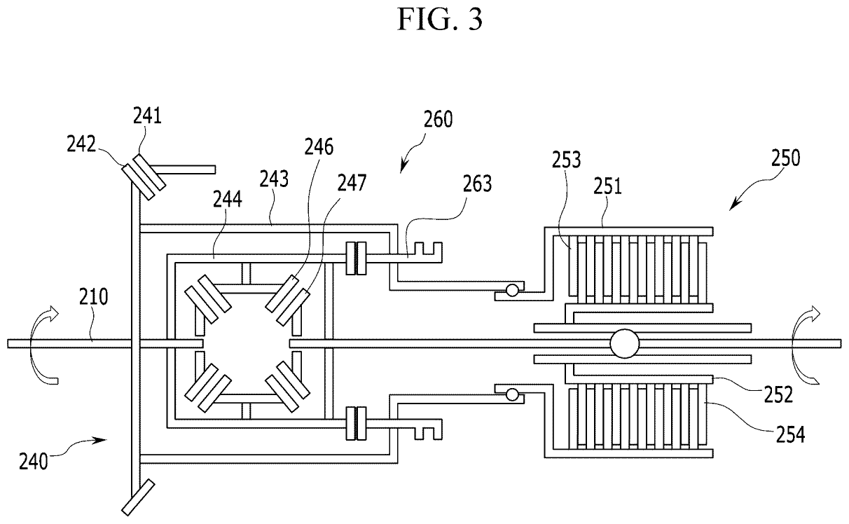

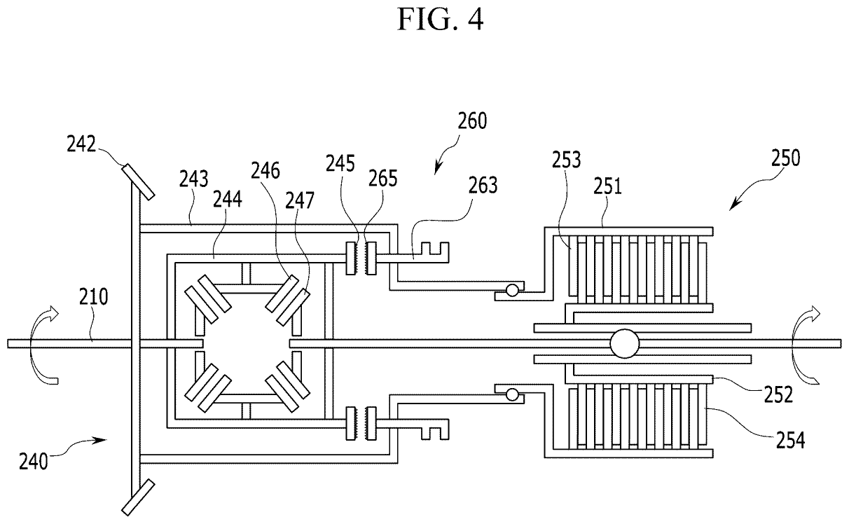

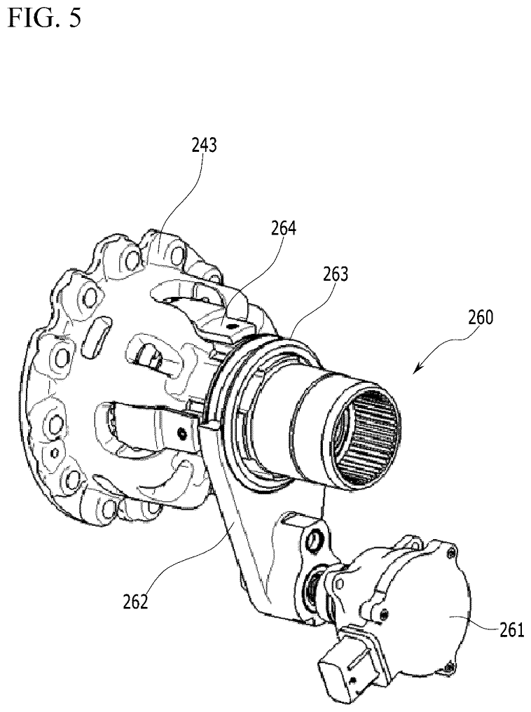

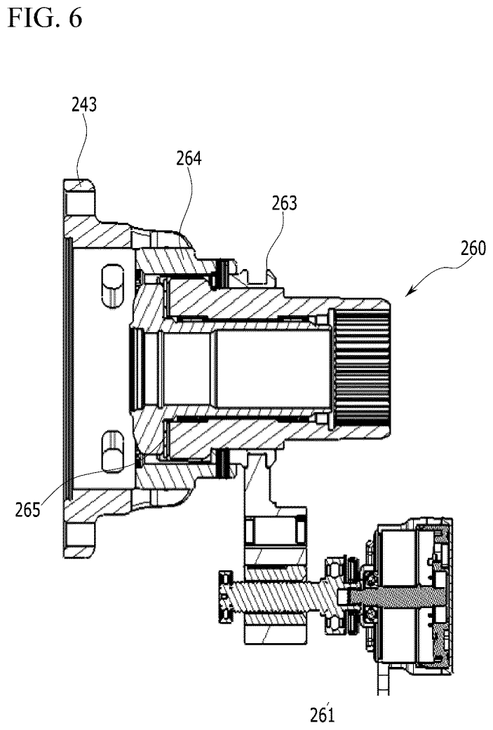

FIG. 3 and FIG. 4 are conceptual views exemplarily illustrating configurations of the differential, the limited-slip differential, and the disconnecting device provided on the auxiliary driveshaft according to the exemplary embodiment of the present disclosure.

With reference to FIG. 3 and FIG. 4, the second differential, the disconnecting device, and the second limited-slip differential may be provided on the auxiliary driveshaft.

The second differential 240 may distribute power, which is transmitted from a second driving source 220 through a second speed reducer 230, to the left and right wheels of the auxiliary driveshaft 210. In the exemplary embodiment of the present disclosure, the auxiliary driveshaft 210 may be a front wheel driveshaft.

The second driving source 220 may generate power required to drive the vehicle. The second driving source 220 may be an electric motor or an engine.

The power generated by the second driving source 220 may be transmitted to the left and right wheels of the auxiliary driveshaft 210 through the second speed reducer 230 and the second differential 240.

The second differential 240 may allow a difference in speed between the left and right wheels provided at two opposite sides of the auxiliary driveshaft 210. To the present end, the second differential 240 may include a second ring gear 242, a second differential case 243, an auxiliary differential case 244, a second spider gear 246, and second side gears 247.

The second ring gear 242 may be gear-engaged to a second pinion gear 241 and rotated by a rotation of the second pinion gear 241.

The second differential case 243 may be coupled to the second ring gear 242 and rotate integrally with the second ring gear 242.

The auxiliary differential case 244 may be provided in the second differential case 243. The auxiliary differential case 244 and the second differential case 243 may be coupled or separated by the disconnecting device 260. A first face spline 245 may be formed on the auxiliary differential case 244.

The disconnecting device 260 may include sleeve 263 and 264 configured to be moved in an axial direction by power, and a second face spline 265 formed at an end portion of the sleeve 263 and 264.

The sleeve 263 and 264 may be moved in the axial direction (e.g., the axial direction of the auxiliary driveshaft) by power generated by a drive portion 261 such as a drive motor or a solenoid. The drive portion 261 is coupled to the sleeve 263 and 264 via a connecting member 262 engaging the drive portion 261 and the sleeve 263 and 264. The sleeve 263 and 264 may be slidably coupled to the second differential case 243 in the axial direction. Therefore, the sleeve 263 and 264 and the second differential case 243 may rotate integrally.

The second face spline 265 formed at the end portion of the sleeve 263 and 264 may be selectively spline-coupled to the first face spline 245 formed on the auxiliary differential case 244.

With reference to FIG. 3, when the sleeve 263 and 264 moves in one direction (e.g., the direction toward the auxiliary differential case) in the axial direction, the second face spline 265 of the sleeve 263 and 264 and the first face spline 245 of the auxiliary differential case are coupled to each other so that the second differential case 243 and the auxiliary differential case 244 are coupled to each other and rotate integrally.

When the auxiliary differential case 244 and the second differential case 243 are coupled, the auxiliary differential case 244 and the second differential case 243 may rotate integrally. Therefore, the power transmitted from the driving source may be transmitted to the left and right wheels of the auxiliary driveshaft 210 through the differential. As necessary, the left and right wheels of the auxiliary driveshaft 210 may be synchronized by the second limited-slip differential 250.

With reference to FIGS. 4, 5 and 6, when the sleeve 263 and 264 moves in the other direction (e.g., the direction toward the auxiliary differential case) in the axial direction, the second face spline 265 of the sleeve 263 and 264 and the first face spline of the auxiliary differential case may be separated. Therefore, the auxiliary differential case 244 and the second differential case 243 rotate independently.

When the auxiliary differential case 244 and the second differential case 243 are separated, the auxiliary differential case 244 and the second differential case 243 may rotate independently of each other.

When the vehicle travels in a two-wheel drive mode in which the vehicle travels only by use of power of the main driveshaft 110, a reverse rotation force is transmitted to the second driving source 220 and the second speed reducer 230 from the wheels of the auxiliary driveshaft 210, which may degrade efficiency of the vehicle.

In the exemplary embodiment of the present disclosure, the disconnecting device 260 separates the auxiliary differential case 244 and the second differential case 243 when the vehicle travels in the two-wheel drive mode, which may prevent a rotation force, which is transmitted from the wheels of the auxiliary driveshaft 210, from being transmitted to the second driving source 220, the second speed reducer 230, and the like. That is, the disconnecting device 260 may prevent the reverse rotation force from being transmitted to the second driving source 220, the second speed reducer 230, and the like from the wheels of the auxiliary driveshaft 210, improving efficiency of the vehicle.

The second spider gear 246 may be provided in the auxiliary differential case 244 and rotate integrally with the auxiliary differential case 244. The second spider gear 246 may be disposed in the auxiliary differential case 244 and rotate and revolve around the auxiliary driveshaft 210.

When the second differential case 243 and the auxiliary differential case 244 are coupled by the disconnecting device 260, the second spider gear 246 rotates about the auxiliary driveshaft 210 together with the second differential case 243 and the auxiliary differential case 244, like a typical differential.

When the second differential case 243 and the auxiliary differential case 244 are separated by the disconnecting device 260, the second differential case 243 does not rotate, and only the auxiliary differential case 244 provided in the second differential case 243 rotates about the auxiliary driveshaft 210.

The second side gears 247 may be gear-engaged to the second spider gear 246 and rotated by the rotation of the second spider gear 246. The second side gears 247 may be provided as a pair of second side gears 247, and the pair of second side gears 247 may be rotatably coupled to the auxiliary driveshaft 210. Therefore, it is possible to allow the difference in speed between the left and right wheels of the auxiliary driveshaft 210.

The second limited-slip differential 250 may include a second clutch pack including second metal plates 253 coupled to a clutch drum 251, and second metal plates 254 coupled to a hub clutch 252.

The second metal plate 253 may be coupled to the clutch drum 251 that rotates integrally with the second differential case 243. Furthermore, the second friction plate 254 may be coupled to the hub clutch 252 that rotates integrally with the auxiliary driveshaft 210. The second differential case 243 and the clutch drum 251 may be spline-coupled and rotated integrally. Furthermore, the hub clutch 252 and the auxiliary driveshaft 210 may be spline-coupled and rotated integrally.

The left and right wheels of the auxiliary driveshaft 210 may be synchronized by clutch torque generated by contact between the second metal plate 253 and the second friction plate 254, and the differential operation between the second spider gear 246 and the second side gear 247 of the second differential 240 may be restricted.

Generally, an electronic limited-slip differential is directly connected to a differential embedded in a speed reducer of the main driveshaft, but a disconnecting device for improving electric power economy is linearly disposed on an auxiliary driveshaft in an axial direction, which causes a lack of an axial space in comparison with the main driveshaft. In addition, because the disconnecting device is configured to couple or separate a driveshaft connected to a side gear of a differential case, an electronic limited-slip differential, which is disposed after the disconnecting device is disposed, cannot be directly connected to the differential case, which makes it difficult to mount the electronic limited-slip differential on the auxiliary driveshaft.

According to the vehicle according to the exemplary embodiment of the present disclosure, the second differential 240 is designed to include a dual casing structure including the second differential case 243 and the auxiliary differential case 244, and the second differential case 243 and the clutch drum 251 of the second limited-slip differential 250 are connected by spline-coupling. Furthermore, the disconnecting device 260 is configured to couple or separate the second differential case 243 and the auxiliary differential case 244.

With the present structure, it is possible to prevent the disconnecting device 260 and the electronic limited-slip differential from interfering with each other and to make it easy to assemble the electronic limited-slip differential to the auxiliary driveshaft 210.

Generally, the limited-slip differential is not provided, or the limited-slip differential is provided only on the main driveshaft 110, which makes it difficult to ensure sufficient traction traveling performance and turning traveling performance.

In contrast, according to the vehicle according to the exemplary embodiment of the present disclosure, the electronic limited-slip differentials may be respectively provided on the main driveshaft 110 and the auxiliary driveshaft 210, improving the traction traveling performance and turning traveling performance of the vehicle.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Furthermore, the term of “fixedly connected” signifies that fixedly connected members always rotate at the same speed. Furthermore, the term of “selectively connectable” signifies “selectively connectable members rotate separately when the selectively connectable members are not engaged to each other, rotate at the same speed when the selectively connectable members are engaged to each other, and are stationary when at least one of the selectively connectable members is a stationary member and remaining selectively connectable members are engaged to the stationary member”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

1. A vehicle comprising:
a first differential configured to allow a difference in speed between left and right wheels of a main driveshaft in the vehicle;
a first limited-slip differential configured to selectively restrict a differential operation of the first differential;
a second differential configured to allow a difference in speed between left and right wheels of an auxiliary driveshaft in the vehicle;
a second limited-slip differential configured to selectively restrict a differential operation of the second differential; and
a disconnecting device provided on the auxiliary driveshaft and configured to selectively block power transmitted from a driving source to the auxiliary driveshaft,
wherein the first differential includes:
a first ring gear;
a first differential case connected to the first ring gear and rotating integrally with the first ring gear;
a first spider gear rotatably mounted on the first differential case and rotating and revolving around the main driveshaft; and
a pair of first side gears rotatably mounted on the main driveshaft and gear-engaged to the first spider gear,
wherein the second differential includes:
a second ring gear;
a second differential case connected to the second ring gear and rotating integrally with the second ring gear;
an auxiliary differential case configured to be selectively coupled to the second differential case by the disconnecting device;
a second spider gear rotatably mounted on the auxiliary differential case and rotating and revolving around the auxiliary driveshaft; and
a second side gear rotatably mounted on the auxiliary driveshaft and gear-engaged to the second spider gear,
wherein the disconnecting device separates or couples the second differential case and the auxiliary differential case, and
wherein the disconnecting device includes a sleeve slidably coupled to the second differential case and selectively coupled to the auxiliary differential case.

2. (canceled)

3. The vehicle of claim 1, wherein the first limited-slip differential includes:
a first hub clutch engaged to the main driveshaft and rotating integrally with the main driveshaft;
a first friction plate coupled to the first hub clutch;
a first clutch drum engaged to the first differential case and rotating integrally with the first differential case; and
a first metal plate coupled to the first clutch drum.

4. The vehicle of claim 3, wherein the main driveshaft and the first hub clutch are spline-coupled each other.

5. The vehicle of claim 3, wherein the first differential case and the first clutch drum are spline-coupled each other.

6. (canceled)

7. The vehicle of claim 1, wherein the auxiliary differential case is provided in the second differential case.

8. The vehicle of claim 1, wherein the second limited-slip differential includes:
a second hub clutch engaged to the auxiliary driveshaft and rotating integrally with the auxiliary driveshaft;
a second friction plate coupled to the second hub clutch;
a second clutch drum coupled to the second differential case and rotating integrally with the second differential case; and
a second metal plate coupled to the second clutch drum.

9. The vehicle of claim 8, wherein the auxiliary driveshaft and the second hub clutch are spline-coupled each other.

10. The vehicle of claim 8, wherein the second differential case and the second clutch drum are spline-coupled each other.

11-12. (canceled)

13. The vehicle of claim 1,
wherein a first face spline is formed on an end portion of the auxiliary differential case, and a second face spline is formed at an end portion of the sleeve, and
wherein the first face spline of the auxiliary differential case and the second face spline of the sleeve are selectively coupled to each other by a drive portion coupled to the sleeve.

14-18. (canceled)
